(19) United States
(12) Patent Application Publication
(10) Pub. No.: US 2013/0170519 A1
(43) Pub. Date: Jul. 4, 2013

(54) Pipeline with Integrated Fiber Optic Cable

(71) Applicant: Vincent Alliot, Paris (FR)

(72) Inventor: Vincent Alliot, Paris (FR)

(73) Assignee: Schlumberger Technology Corporation

(21) Appl. No.: 13/816,476

(22) PCT Filed: Aug. 22, 2011
(86) PCT No.: PCT/EP11/04236

§ 371 Date: Mar. 11, 2013

Related U.S. Application Data
(60) Provisional application No. 61/378,987, filed on Sep. 1, 2010.

(51) Int. Cl. F16L 1/26; G01K 11/32

(52) U.S. Cl. CPC F16L 1/26; G01K 11/32
USPC 374/161; 405/170; 29/458; 29/460

(57) ABSTRACT

Apparatus and methods for integrating a fiber optic cable (116) with a pipeline (104) are described. An example pipeline having an integrated fiber optic cable includes a plurality of pipe sections (119a, 119b), where each of the pipe sections has a thermally insulating outer layer (200, 202) and ends not covered by the outer layer. The ends of each of the pipe sections are welded to respective ends of other pipe sections to form field joints (111a) at the welded ends. The pipeline also includes a fiber optic cable, where first portions (120) of the fiber optic cable are in contact with some of the pipe sections at some of the field joints and where second portions of the fiber optic cable between the first portions are fixed to the outer layer. A coating is applied to cover each of the first portions of the fiber optic cable to integrate the fiber optic cable with the pipeline.

### RELATED APPLICATION

This patent claims the benefit of the filing date of U.S. Provisional Patent Application No. 61/378,987, filed on Sep. 1, 2010, the entire disclosure of which is incorporated by reference herein.

### FIELD OF THE DISCLOSURE

The present disclosure relates to fluid pipelines and, more particularly, to integrating a fiber optic cable with a pipeline.

### BACKGROUND OF THE DISCLOSURE

The production and distribution of hydrocarbon fluids such as oil and natural gas typically involves the use of long pipelines. Some production pipelines, such as those used in subsea environments, are thermally insulated to facilitate maintenance of a temperature of a fluid in the pipeline above a certain temperature. For example, the fluid may be maintained above a temperature at which wax deposits and/or hydrate plugs form. Thus, pipeline operators are often interested in monitoring the temperature profile along a pipeline, especially during a shut down operation, a start up operation and/or when the pipeline is actively heated.

Production pipelines typically include a protective (e.g., polymer or rubber) coating over the outer metallic skin or surface of the pipe sections making up the pipeline to provide thermal insulation and/or to protect the pipeline from the environment in which the pipeline is used. For example, without such a protective coating, a steel pipeline would quickly corrode and become compromised by the salt water of a subsea environment. However, measuring or monitoring the temperature profile of a coated pipeline can present difficulties, particularly when the coating interposes temperature sensors and the underlying metallic surface of the coated pipeline, thereby forming a relatively high thermal resistance and preventing close contact between the sensors and the metallic surface of the pipeline. As a result, once a pipeline has been thermally insulated with a coating, obtaining accurate pipeline temperatures, as well as measuring other pipeline parameters such as strain and deformation, becomes difficult.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic diagram of an example ship-based pipe laying operation in accordance with the teachings of this disclosure.

FIGS. 2A and 2B depict the manner in which a fiber optic cable may be integrated with a pipeline using the example pipe laying operation of FIG. 1.

FIG. 3 depicts a cut-away view of a field joint portion of the example pipeline of FIGS. 1, 2A and 2B at which a loop-shaped portion of the fiber optic cable has been integrated or embedded.

FIG. 4 is a schematic diagram of another example manner in which a fiber optic cable may be integrated with a pipeline during a pipe laying operation.

### DETAILED DESCRIPTION

It is to be understood that the following disclosure provides different embodiments or examples for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In one known configuration to measure temperature of a pipeline using a fiber optic cable, relatively long sections of pipe (e.g., about 1 kilometer long) may be insulated using a pipe-in-pipe arrangement. Each of these pipe sections also includes a separate piece of fiber optic cable extending the length of the section and between the inner metallic pipe and the outer insulating pipe or layer. When laying a pipeline formed with these long pipe sections, the pipe sections are welded end-to-end and the separate pieces of the fiber optic cable are spliced together at the welded ends. In this configuration, the fiber optic cable is essentially continuously thermally coupled along the length of the pipeline. In other words, the thermal resistance between the fiber optic cable and the pipe sections is relatively constant along the length of the pipeline.

However, with the foregoing known configuration, each splice of the fiber optic cable significantly degrades the ability of the fiber optic cable to accurately measure parameters of the pipeline. Further, making such splices, particularly for ship-based pipe laying operations, is time consuming and expensive. Consequently, for pipe laying operations utilizing pre-coated pipe sections, which are typically relatively short (e.g., between 12 and 48 meters), this known approach involving splicing of the fiber optic cable at each of the field joints between pipe sections becomes impractical. Specifically, the large number of fiber optic cable splices that would be needed to fabricate a typical pipeline with pre-coated pipe sections would be extremely time-consuming and cost prohibitive. Further, such a large number of splices would significantly degrade the transmission qualities of the fiber optic cable, thereby making accurate measurements of pipeline parameters very difficult or impossible.

The examples described herein eliminate the need for splicing a fiber optic cable at each field joint between pipe sections of a pipeline. More particularly, one or more aspects of the present disclosure relate to fluid pipelines having an integrated, continuous fiber optic cable configured to enable distributed sensing of one or more parameters associated with the pipelines. More specifically, the example fluid pipelines described herein may be composed of coated pipe sections that are welded together at respective field joints which, initially, are uncoated areas of the pipe sections. A continuous length of fiber optic cable, which has been gathered at spaced intervals to form loop-shaped portions, is integrated with the welded pipe sections by attaching the loop-shaped portions to the outer surfaces of the field joints without any intervening layer of thermally insulating material. In other words, the loop-shaped portions are attached to the outer surfaces of the field joints to provide a relatively low thermal resistance between the loop-shaped portions and the metal of the field joints. For example, the loop-shaped portions may be in contact with bare metal surfaces of the field joints, a relatively thin painted or plated layer that covers the metal of the field joints and/or in contact with any other surface treatment(s) providing a relatively low thermal resistance between the field joint and the loop-shaped portions.

The attachment of the loop-shaped portions of the fiber optic cable to the field joints of the pipe sections may be accomplished by attaching or wrapping the loop-shaped portions at, about or around the field joints and may further include tie-wraps, bands and/or any other suitable fastener(s) to hold the loop-shaped portions in contact with the field joints. Such a close or relatively low thermal resistance contact between the loop-shaped portions of the fiber optic cable and the metallic surfaces of the field joints enables the fiber optic cable to accurately measure strain, temperature and vibration as well as other parameters of the pipeline formed by the pipe sections via, for example, Distributed Sensor Technology (DST).

DST typically involves the transmission of light (e.g., provided by a laser light source or other coherent light source) along an optical fiber and accurately measuring (via measurement electronics) the time-of-flight and spectral characteristics of the light that is backscattered by the lattice structure of the optical fiber. Light is backscattered as a result of photons striking the vibrating lattice. Such backscattered light or photons may exhibit a spectral shift (e.g., an increase or decrease in frequency) relative to the originating light source and in proportion to the level of vibration in the lattice. Thus, because the vibration of the lattice of the optical fiber is proportional to the temperature of the fiber, the spectral shift exhibited by the backscattered light varies in proportion to the temperature of the fiber. Therefore, measuring the spectral characteristics of the backscattered light enables a determination of the temperature of the optical fiber and, thus, the temperature of a pipeline to which the optical fiber is attached. In a similar manner, mechanical strain of the optical fiber causes spectral shifts and, thus, the characteristics of backscattered light may also be used to measure mechanical strain, deformation, vibration or other parameters. The details associated with DST and the use of DST to measure temperature, strain, deformation and vibration are generally well known and, thus, are not described further herein.

Once the loop-shaped portions are attached to the field joints, a coating may be applied (e.g., via a pouring operation) to cover the field joints and the loop-shaped portions. The coating applied to cover the field joints and the loop-shaped portions may also be joined to the coated portions of the pipe sections, thereby fully encapsulating the pipe sections and any pipeline formed by the pipe sections with an outer protective layer to prevent corrosion of the pipeline and/or other damage to the pipeline. The portions of the fiber optic cable between the loop-shaped portions may be further pegged or secured to the outer surfaces of the pipe sections or pipeline via, for example, tie-wraps, bands and/or any other fastener(s).

Thus, in accordance with the examples described herein, a continuous length of fiber optic cable may be integrated with a pipeline to facilitate and/or improve distributed sensing of parameters along the length of the pipeline without compromising the integrity of an outer protective layer or coating. In particular, as a result of the direct, close or relatively low thermal resistance contact between the loop-shaped portions of the fiber optic cable and the metallic outer surfaces or skin of the pipe sections at the field joints, the fiber optic cable may be used to accurately measure pipeline parameters such as temperature (e.g., of the pipe sections and/or the fluid flowing therein), strain (e.g., strain imposed on the pipe sections), deformation and vibration, as well as other parameters. Further, because the loop-shaped portions are covered or coated in a manner that establishes an essentially continuous coated outer surface along the pipe sections and the pipeline formed thereby, the thermal insulation and protective properties of the outer layer or coating on the pipeline are not compromised. As a result, the pipeline may remain highly resistant to the damaging (e.g., corrosive) effects of its environment (e.g., sea water) and may also provide a high degree of thermal insulation, thereby preventing fluid flowing in the pipeline from developing plugs, deposits or other impediments to fluid flow.

In the examples described herein, the coated pipe sections may have one or more coating layers suited to withstand the particular environment in which the resulting pipeline is to be used. For example, a thermally insulating coating material may be used in pipeline applications, such as subsea applications, where maintaining the temperature of the fluid in the pipeline above a certain temperature is required. In particular, the coating(s) used to cover the welded field joints of the pipe sections and/or the portions of the pipeline between the field joints may be a wet type or a pipe-in-pipe type coating.

Further, the loop-shaped fiber optic cable portions of the examples described herein may be formed using predetermined or selected lengths of a continuous fiber optic cable. The predetermined length(s) of the loops may be based on an overall length of the pipeline and/or a spatial resolution of the fiber optic cable and/or measurement electronics coupled to the fiber optic cable. In the examples described herein, the predetermined length of fiber optic cable used to form the loops may be between about one meter and about ten meters. For example, a relatively shorter pipeline having relatively high resolution measurement electronics may use loop-shaped portions formed with approximately one meter long portions of the continuous fiber optic cable. On the other hand, a relatively longer pipeline having relatively low resolution measurement electronics may use loop-shaped portions formed with approximately ten meter long portions of the fiber optic cable. However, other predetermined lengths may be used without departing from the scope of this disclosure.

Additionally, while loop-shaped portions are described in the examples herein, the portions of the fiber optic cable that are attached to the field joints may have a shape other than a loop shape. For example a spiral shape may be used instead of a loop shape. More generally, any manner of wrapping or otherwise attaching portions of a continuous fiber optic cable to be in close contact (e.g., via a low thermal resistance path) with pipe sections of a pipeline before those sections are thermally insulated or coated may be used instead. More specifically, in another example described herein, portions of a continuous fiber optic cable may be spiral wound or spooled about ends of pipe sections by rotating the pipe sections before welding abutting pipe sections.

Further, the manner in which the portions of the fiber optic cable attached to the field joints are distributed over the outer surfaces surrounding the field joints may be varied to suit the needs of a particular application. For example, the fiber optic cable may extend only partially, fully or multiple times around the circumference of the field joint. In cases where the fiber optic cable extends fully or multiple times around the circumference of the field joint, the parameter being measured via the fiber optic cable may provide measurements more representative of an average value of the parameter, which may be useful to, for example, control temperature of a fluid flowing in a pipeline.

Still further, in the examples described herein, the portions of the fiber optic cable between the portions that are attached to the field joints may be attached to an outermost thermally insulating surface of the pipeline (e.g., the outermost surface of the originally coated portions of the pipe sections between the uncoated ends of the pipe sections). In this manner the portions of the fiber optic cable between the field joints may be used to measure or monitor a parameter of the pipeline associated with the outermost surface or coating such as a coating skin temperature, pipeline stress levels, buckling of the pipeline, and integrity of the coating, among other parameters.

In the examples described herein, the portions of the fiber optic cable in close contact with the pipe sections are not necessarily attached or coupled to every field joint or immediately successive field joints. Rather, these may be attached every second, third, fourth, etc. field joint such that these portions are spaced apart a number of field joints to satisfy the needs of a particular application.

The example pipelines having integrated fiber optic cables described herein may be employed in land-based or on-shore applications as well as off-shore or subsea applications. For subsea applications, the example pipelines may be fabricated as part of a pipe laying operation conducted from a ship or other vessel. For these ship-based pipe laying operations, which may be, for example, J-lay or S-lay pipe laying operations, the pipe sections may be welded via welding stations and a wrapping station may be used to draw a continuous length of fiber optic cable from a spool or reel and wrap the loop-shaped portions of the fiber optic cable at some of the welded field joints as specified for the particular application. A coating station may then apply a coating to cover the loop-shaped portions and the field joints to integrate the fiber optic cable with the pipeline. Portions of the fiber optic cable between the loop-shaped portions may be pegged to the outer surface of the pipe sections of the pipeline via tie-wraps or the like at, for example, a twelve o'clock position so that the completed pipeline may pass through a stinger or any other pipe laying equipment without damaging the integrated fiber optic cable.

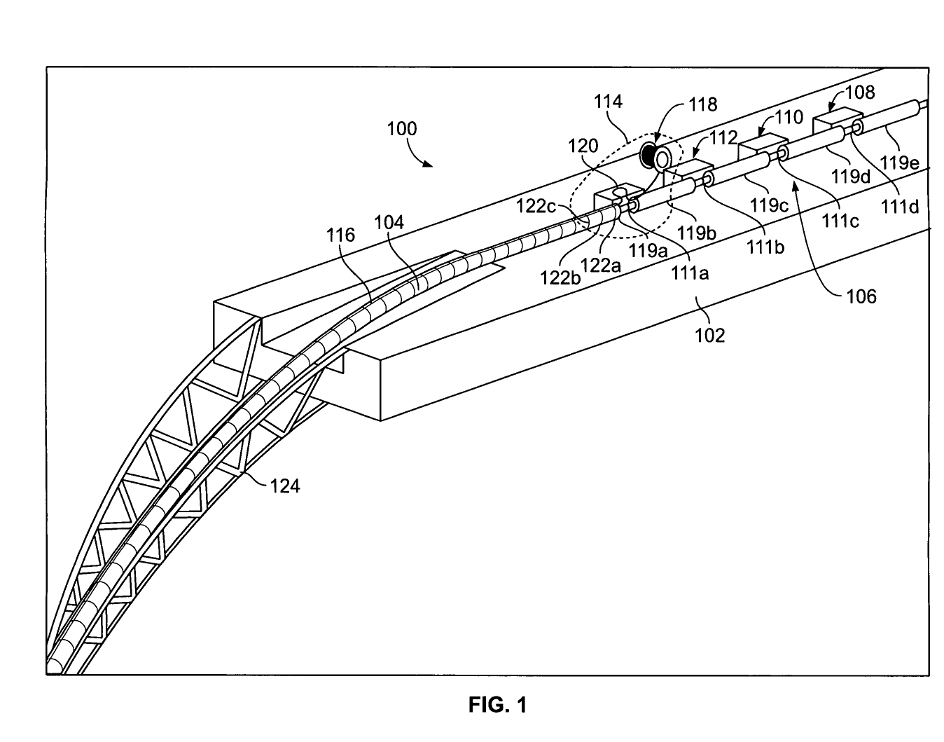

Now turning in detail to the figures, FIG. 1 is schematic diagram of an example ship-based pipe laying operation 100 in accordance with the teachings of this disclosure. As shown in FIG. 1, a ship 102 is used to fabricate and lay a subsea pipeline 104. In this particular example, the ship is an S-lay ship and, thus, the pipe laying operation 100 is an S-lay type pipe laying operation. However, the teachings of this disclosure may be applied to any other type of pipe laying operation where pipe joints of a given length are assembled to fabricate a continuous pipeline including, for example, a J-lay type pipe laying operation or terrestrial pipe laying operations.

The ship 102 includes a firing line 106, which is an onboard facility to fabricate or assemble the pipeline 104. The firing line 106 includes a plurality of assembly or fabrication stations including pipefitting and welding stations 108 and 110, a non-destructive testing station 112, and a wrapping and coating station 114. The pipefitting and welding stations 108 and 110 and the non-destructive testing station 112 are well-known types of pipeline assembly or fabrication stations. The wrapping and coating station 114, in contrast to the known approach described above, integrates a continuous fiber optic cable 116 along the length of the pipeline 104 and, thus, as described in more detail below, eliminates the need to splice pieces of fiber optic cable at each of the field joints between the pipe sections forming a pipeline. As depicted, the wrapping and coating station 114 includes a spool or reel 118 to dispense the fiber optic cable 116. The operations associated with the wrapping may be performed manually, automatically or via a combination of manual and automated activity.

In operation, coated pipe sections 119a-e are welded together (end-to-end) at the pipefitting and welding stations 108 and 110 to form field joints 111a-d. The non-destructive testing station 112 then tests the integrity of the welds or the field joints 111a-d. At the wrapping and coating station 114, a predetermined length of the fiber optic cable 116 is drawn off of the reel 118 and gathered to form a loop-shaped portion 120 of the fiber optic cable 116. The loop-shaped portion 120 is then attached (e.g., via wrapping) to the exposed field joint 111a to provide a relatively low thermal resistance between the metal of the field joint 111a and the loop-shaped portion 120 of the fiber optic cable 116. A coating is then applied (e.g., via a pouring operation) to cover the field joint 111a and the loop-shaped portion 120, thereby integrating the fiber optic cable 116 with the pipeline 104.

Multiple loop-shaped portions, such as the loop-shaped portion 120, of the fiber optic cable 116 may be attached to multiple field joints along the length of the pipeline 104. These loop-shaped portions of the fiber optic cable 116 may not be attached to every field joint and, thus, may be attached to every second, third, fourth, etc. field joint as needed to suit a particular application. Further, portions of the fiber optic cable 116 between the loop-shaped portions and the field joints may be fixed (e.g., via a pegging operation) to an outer surface or layer of the pipeline 104 via tie-wraps, band, straps or other fasteners, three of which are indicated at reference numbers 122a, 122b and 122c. As depicted in FIG. 1, the fiber optic cable 116 may be fixed to the outer surface of the pipeline 104 in a position (e.g., a twelve o'clock position) to prevent damage to the fiber optic cable 116 as it passes through a stinger 124 and/or any other equipment associated with the pipe laying operation 100.

The integrated fiber optic cable 116 may be used to sense one or more parameters associated with the pipeline 104 during operation of the pipeline 104. For example, parameters such as temperature, strain, deformation and/or vibration may be sensed and monitored along the length of the pipeline 104. More specifically, an accurate measurement of the temperature of the fluid within the pipeline 104 may be obtained via the loop-shaped portions (e.g., the loop-shaped portion 120) attached to the field joints (e.g., the field joints 111a-d) due to the relatively low thermal resistance between the loop-shaped portions and the metal of the pipe sections 119a-e. These fluid temperature measurements may represent the temperature of the fluid within the pipeline 104 near the field joints and, thus, can be used to develop a temperature profile of the fluid along the length of the pipeline 104. As described above, the portions of the fiber optic cable 116 between the loop-shaped portions are attached to an outer layer or surface of the pipeline 104 and, thus, may be used to sense or monitor the skin temperature of this outer layer or surface (e.g., the skin temperature of the protective coating on the pipeline 104). Such a skin temperature may be used to assess the performance of the coating and/or whether the coating has been damage or compromised. Additionally, the loop-shaped portions of the fiber optic cable 116 and/or the portions of the fiber optic cable 116 between the loop-shaped portions may be used to sense or monitor other pipeline parameters such as deformation, which may occur as lateral or vertical buckling that may exceed, for example, 1 to 2 meters of deflection. Parameters associated with stress levels along the pipeline 104 during the laying operation 100 may also be monitored using, for example, touch down point. Further, accidental flooding of the pipeline 104 during the laying operation 100 can also be monitored. Similarly, leaks along the pipeline 104 during operation may be monitored. Still further, the fiber optic cable 116 may be used to detect or monitor vibrations such as vortex induced vibrations and/or flow induced vibrations.

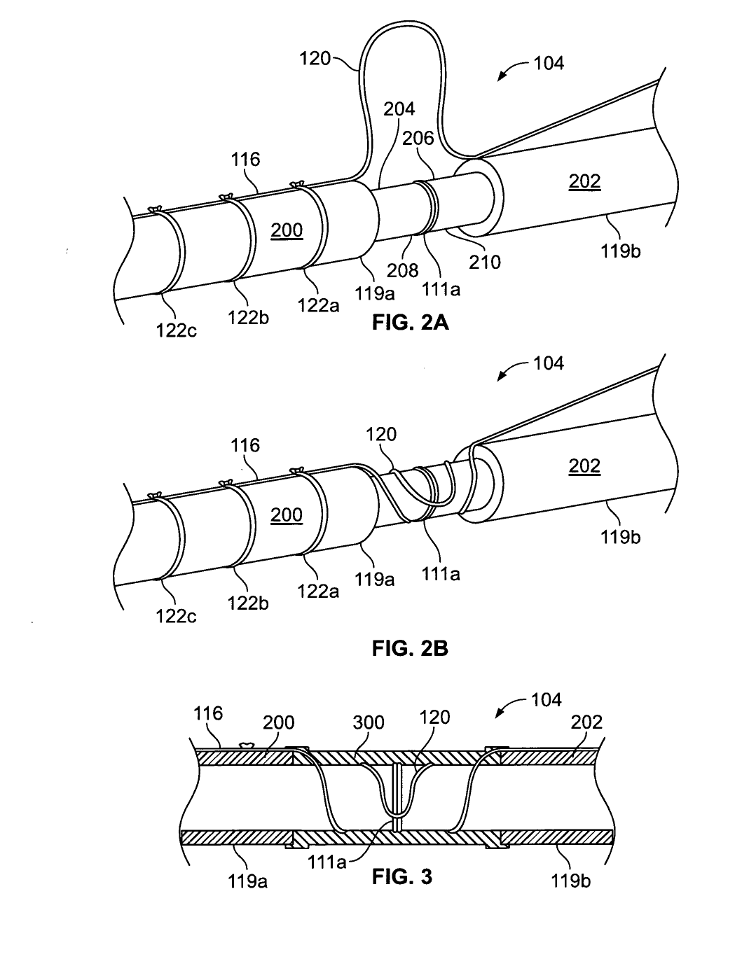

FIGS. 2A and 2B depict in more detail the manner in which the fiber optic cable 116 may be integrated with the pipeline 104 using the example pipe laying operation 100 of FIG. 1. Turning first to FIG. 2A, the coated pipe sections 119a-b have respective coatings or outer layers 200 and 202. The outer layers 200 and 202 may be a thermally insulating material such as polypropylene approximately 2 centimeters (cm) to 8 cm thick or any other thickness or type of coating suitable to thermally insulate underlying metal pipe portions 204 and 206. Additionally, the outer layers 200 and 202 may protect the metal pipe portions 204 and 206 from environmental factors (e.g., seawater) that could compromise the integrity of the pipeline 104. The pipe sections 119a-b also have uncoated ends 208 and 210 that are abutted and welded at the field joint 111a.

The fiber optic cable 116 is attached to the outer layers 200 and 202, as depicted by way of example, with the tie-wraps 122a-c in an approximately twelve o'clock position. The loop-shaped portion 120 of the fiber optic cable 116 is formed by gathering a predetermined length of the fiber optic cable 116 adjacent to the field joint 111a. The length of the fiber optic cable 116 gathered to form the loop-shaped portion 120 may be selected based on a spatial resolution associated with the fiber optic cable 116 and/or any measuring electronics coupled to the fiber optic cable 116. Alternatively or additionally, the length gathered may be selected based on an overall length of the pipeline 104. For a wide variety of applications, the length gathered may range between about one meter and ten meters. However, any other length may be used as needed and based on the particular application. Generally, the gathered length needed increases as the length of the pipeline 104 increases and as the resolution of the fiber optic cable 116 and/or the measuring electronics decrease. In applications where the pipeline 104 is less than 15 kilometers in length, the gathered length to form the loop-shaped portion 120 may be about two to three meters. On the other hand, if the overall length of the pipeline 104 is greater than about 15 kilometers, the gathered length to form the loop-shaped portion 120 may be about ten meters.

Turning to FIG. 2B, the loop-shaped portion 120 is shown wrapped at or about the field joint 111a. As depicted in FIG. 2B, the loop-shaped portion 120 wraps somewhat more than once around the circumference of the field joint 111a and also extends substantially across the width of the uncoated ends 208 and 210. When attached in this manner to the field joint 111a, the loop-shaped portion 120 of the fiber optic cable 116 can provide an average temperature of, for example, the fluid within the pipeline 104 near the field joint 111a. Such an average temperature value may average from the top to the bottom of the pipeline 104, from the right side to the left side and/or across a length of the pipeline 104 to which the loop-shaped portion 120 is attached. Although not shown, one or more tie-wraps or other fasteners may be used to hold the loop-shaped portion 120 in place against the surface of the field joint 111a. Further, while the manner in which FIG. 2B depicts the loop-shaped portion 120 to be wrapped, the attachment or wrapping of the loop-shaped portion 120 can be varied to suit the needs of a particular application.

FIG. 3 depicts a cut-away view of field joint portion 111a of the example pipeline 104 of FIGS. 1, 2A and 2B at which the loop-shaped portion 120 of the fiber optic cable 116 has been integrated or embedded. In FIG. 3, a thermally insulating coating 300 has been applied to cover the field joint 111a and the loop-shaped portion 120 to integrate the fiber optic cable 116 with the pipeline 104. The coating 300 may be applied via pouring or any other operation and may seal against the outer layers 200 and 202 of the pipe sections 119a-b, thereby fully encapsulating the pipe sections 119a-b with a protective coating or barrier.

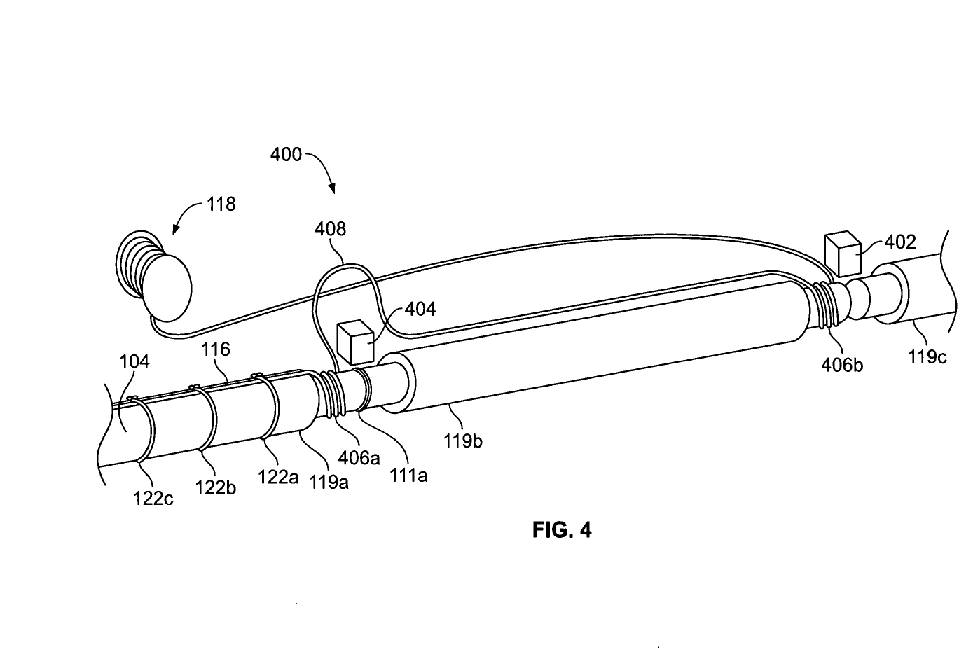

FIG. 4 is a schematic diagram of another example manner in which a fiber optic cable may be integrated with a pipeline during a pipe laying operation 400. In the example pipe laying operation 400 of FIG. 4, a first pipefitting and welding station 402 and a second welding station 404 may be used to join and weld the pipe sections 119a-c in a manner similar to that described in connection with the stations 108 and 110 of FIG. 1. However, in this example, prior to welding, the pipe sections 119a-c are rotated to form coils, winding portions, or spiral wrapped portions 406a-b at one end of each of the pipe sections 119a-c as depicted in FIG. 4. A slack or loop portion 408 may be formed near the second welding station 404 to facilitate operation of the welding station 404. For example, the second welding station 404 may be an orbital type welding device and, thus, may require access to all sides of the portions of the pipe sections 119a-c to be welded.

When the fiber optic cable 116 is coiled or wound about the pipe sections at the first pipefitting and welding station 402, the winding may be performed to maintain a very tight coil. Then, at the second welding station 408, after the welding has been completed, the coils 406a-b may be spread out across the field joint 111a to better cover the length of the field joint 111a. Additionally, the slack or loop portion 408 may also be attached to the field joint 111a in a manner similar to that shown and described in connection with FIGS. 2A and 2B, and the field joint 111a may then be covered or insulated as shown and described in connection with FIG. 3. In some other examples, the second welding station 408 of FIG. 4 may not be used (e.g., some J-lay pipe laying operations)

Accordingly, the foregoing disclosure introduces a pipeline having an integrated fiber optic cable. Specifically, the pipeline includes a plurality of pipe sections and each of the pipe sections has a thermally insulating outer layer and ends not covered by the outer layer. The ends of each of the pipe sections are welded to respective ends of other pipe sections to form field joints at the welded ends. Additionally, the pipeline includes a fiber optic cable, where first portions of the fiber optic cable are in contact with some of the pipe sections at some of the field joints and second portions of the fiber optic cable between the first portions are fixed to the outer layer. A coating is applied to cover each of the first portions of the fiber optic cable to integrate the fiber optic cable with the pipeline.

The disclosure also introduces a method of integrating a fiber optic cable with a pipeline. The method involves welding a field joint between first and second pipe sections of the pipeline, coupling a first portion of a fiber optic cable to the first and second pipe sections at the welded field joint, applying a coating to the pipe sections at the welded field joint to cover the first portion of the fiber optic cable to integrate the fiber optic cable with the pipeline, and coupling a second portion of the fiber optic cable to outer surfaces of the pipe sections.

The disclosure introduces another method of integrating a fiber optic cable with a pipeline. This method involves coupling loop-shaped portions of the fiber optic cable to respective welded field joints of the pipeline, where the respective welded field joints are spaced apart a number of field joints, and applying a coating to cover the coupled loop-shaped portions of the fiber optic cable to integrate the fiber optic cable with the pipeline.

The foregoing disclosure outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. A pipeline having an integrated fiber optic cable, comprising:
a plurality of pipe sections, each of the pipe sections having a thermally insulating outer layer and ends not covered by the outer layer, the ends of each of the pipe sections being welded to respective ends of other pipe sections to form field joints at the welded ends;
a fiber optic cable, wherein first portions of the fiber optic cable are in contact with some of the pipe sections at some of the field joints and wherein second portions of the fiber optic cable between the first portions are fixed to the outer layer; and
a coating applied to cover each of the first portions of the fiber optic cable to integrate the fiber optic cable with the pipeline.

2. The pipeline of claim 1, wherein each of the first portions forms a loop-shaped portion that is wrapped on the pipe sections at its respective field joint.

3. The pipeline of claim 1, wherein each of the first portions has a predetermined length based on a spatial resolution associated with the fiber optic cable.

4. The pipeline of claim 3, wherein the predetermined length is based on an overall length of the pipeline.

5. The pipeline of claim 4, wherein the predetermined length is between about 1 meter and about 10 meters.

6. The pipeline of claim 1, wherein the first portions are spaced apart a number of field joints along a length of the pipeline.

7. The pipeline of claim 1, wherein the coating comprises a thermally insulating material.

8. The pipeline of claim 7, wherein the thermally insulating material is applied via a pouring operation.

9. The pipeline of claim 1, wherein the coating comprises wet or a pipe-in-pipe type coating.

10. The pipeline of claim 1, wherein the second portions of the fiber optic cable are fixed to the outer layer of the pipeline via a pegging operation.

11. The pipeline of claim 1, wherein the second portions of the fiber optic cable are fixed to the outer layer of the pipeline via at least one of tie-wraps or bands.

12. The pipeline of claim 1, wherein the second portions of the fiber optic cable are fixed to the outer layer of the pipeline to enable the fiber optic cable to pass through a stinger without damage.

13. The pipeline of claim 12, wherein the second portions of the fiber optic cable are fixed to the outer layer of the pipeline in an approximately twelve o'clock position.

14. The pipeline of claim 1, wherein the fiber optic cable is configured to monitor a parameter of the pipeline.

15. The pipeline of claim 14, wherein the parameter comprises temperature, vibration or strain.

16. The pipeline of claim 14, wherein the parameter comprises a distributed parameter along a length of the pipeline.

17. The pipeline of claim 14, wherein the parameter comprises an average parameter value.

18. The pipeline of claim 17, wherein the first portions are in contact with some of the pipe sections at some of the field joints to measure the average parameter value.

19. A method of integrating a fiber optic cable with a pipeline, comprising:
welding a field joint between first and second pipe sections of the pipeline;
coupling a first portion of a fiber optic cable to the first and second pipe sections at the welded field joint;
applying a coating to the pipe sections at the welded field joint to cover the first portion of the fiber optic cable to integrate the fiber optic cable with the pipeline; and
coupling a second portion of the fiber optic cable to outer surfaces of the pipe sections.

20. The method of claim 19 further comprising coupling multiple portions of the fiber optic cable to welded field joints of the pipeline, wherein the multiple portions are spaced apart a number of field joints.

21. The method of claim 19, wherein applying the coating comprises pouring the coating.

22. The method of claim 19, wherein the welding, the coupling of the first portion, the applying of the coating and the coupling of the second portion are performed as part of a pipe laying operation on a ship.

23. The method of claim 22, wherein the pipe laying operation is one of a J-lay operation or an S-lay operation.

24. The method of claim 19, wherein coupling the second portion of the fiber optic cable comprises pegging the second portion of the fiber optic cable to the outer surfaces of the pipe sections.

25. The method of claim 19 further comprising forming the first portion of the fiber optic cable into a loop shape prior to coupling the first portion of the fiber optic cable to the first and second pipe sections.

26. The method of claim 19, wherein coupling the first portion of the fiber optic cable to the first and second pipe sections comprises wrapping the first portion of the fiber optic cable on the first and second pipe sections at the field joint.

27. A method of integrating a fiber optic cable with a pipeline, comprising:
coupling loop-shaped portions of the fiber optic cable to respective welded field joints of the pipeline, the respective welded field joints being spaced apart a number of field joints; and
applying a coating to cover the coupled loop-shaped portions of the fiber optic cable to integrate the fiber optic cable with the pipeline.

28. The method of claim 27, wherein coupling the loop-shaped portions of the fiber optic cable to the respective welded field joints comprises wrapping the loop-shaped portions on the pipeline at the respective field joints.

29. The method of claim 27 further comprising coupling other portions of the fiber optic cable to outer surfaces of the pipeline.
